(19) United States
(12) Patent Application Publication
(10) Pub. No.: US 2012/0205969 A1
(43) Pub. Date: Aug. 16, 2012

(54) Power Source Control Circuit for Working Machine

(75) Inventors: Motoyuki YABUUCHI, Tsuchiura-shi (JP); Tadatoshi Shimamura, Tsuchiura-shi (JP)

(73) Assignee: Hitachi Construction Machinery Co., Ltd., Tokyo (JP)

(21) Appl. No.: 13/359,021

(22) Filed: Jan. 26, 2012

(30) Foreign Application Priority Data
Feb. 10, 2011 (JP) 2011-027266

(51) Int. Cl. B60L 1/00

(52) U.S. Cl. 307/9.1

(57) ABSTRACT

A power source control circuit for a working machine includes an electric circuit connecting a key cylinder, controller and accessories. The electric circuit is provided with a first self-holding relay drivable directly by a relay drive signal outputted from the controller and second self-holding relays drivable in conjunction with the first relay. When a gate lock switch is switched to a lock position while an engine is running, the controller outputs an engine stop signal at a subsequent predetermined timing to stop the running of the engine, and also outputs the relay drive signal to drive the first relay and second relays such that a key-on power supply and an accessory power supply are each held in a cut-off state.

### CROSS-REFERENCE TO RELATED APPLICATION

This application claims the priority of Japanese Patent Application 2011-027266 filed Feb. 10, 2011, which is incorporated herein by reference.

### BACKGROUND OF THE INVENTION

1. Field of the Invention

This invention relates to a power source control circuit for a working machine, and specifically to a means for surely preventing battery fattening during an idle stop.

2. Description of the Related Art

A working machine such as a hydraulic excavator or wheel loader is also provided with idle stop function that automatically stops an engine upon discontinuation of work to reduce wasteful fuel consumption and noise production. An idle stop of a working machine generally relies upon a construction that stops an engine when a gate lock switch, which is operable in conjunction with a gate lock lever arranged at an entrance/exit of an operator's cab, is switched to a lock position where drive of hydraulic equipment by control levers is disabled.

As an engine control system for a working machine, said system being equipped with idle stop function of this type, the assignee of the present application previously proposed an engine control system that, when an operator switches a gate lock switch to a lock position for the discontinuation of work, a controller counts the time elapsed since the switching of the gate lock switch, an engine stop signal is outputted from the controller to an engine control means when a predetermined time set beforehand has elapsed, and further, an engine drive signal is outputted from the controller to the engine control means when the operator operates the gate lock switch to an unlock position where drive of hydraulic equipment by control levers is enabled, to resume the work (see, for example, JP-B-3797805).

According to the engine control system of the above-cited patent document, even when the engine is automatically stopped upon an elapse of the predetermined time after the switching of the gate lock switch to the lock position, the engine can be automatically restarted by simply switching the gate lock switch to the unlock position where drive of the hydraulic equipment by the control levers is enabled again. It is, therefore, possible to eliminate the cumbersomeness that an engine key would otherwise have to be turned again.

Even after the engine has been brought to an idle stop state in the engine control system disclosed in the above-cited patent document, however, a key switch (ignition switch) is held at an ON position so that a supply of electric power from a battery to accessories cannot be stopped. If the idle stop state continues for a long time, the remaining battery charge drops, and in the worst case, battery flattening takes place. Occurrence of such battery flattening requires a large amount of labor to transport the working machine to a place where charging equipment is installed, and moreover, also requires a long time for charging. Therefore, the work efficiency is significantly lowered. Such an inconvenience arises, for example, when the operator leaves from the working machine for another work or purpose without turning off the ignition. Different from a passenger car, a working machine can be hardly determined whether or not it is in working (operation) when it is merely seen to be parking. There is, accordingly, a tendency to determine, based on standstill of an engine, that work is no longer continued. Such an error is prone to occur.

It is to be noted that, when an electric circuit is configured to cut off a connection circuit between a battery and accessories by an instruction from a controller upon being brought to an idle stop state or at an adequate time after that, the supply of electric power from the battery to the accessories is stopped to reduce wasteful consumption of the battery power insofar as the controller remains in operation. Once the controller is shut down, however, the circuit between the battery and the accessories returns to a conductive state, and therefore, such an electric circuit cannot be applied as a power source control circuit for a working machine if nothing is done on the electric circuit.

### SUMMARY OF THE INVENTION

With such problems of the related art in view, the present invention has as an object thereof the provision of a power source control circuit for a working machine, which, after an engine is brought to an idle stop state, can automatically stop a supply of power from a battery to accessories, thereby making it possible to surely preventing battery flattening.

To achieve the above-described object, the present invention provides, in one aspect thereof, a power source control circuit for a working machine, said power source control circuit comprising an engine for driving a hydraulic pump and an alternator, a battery for storing electric power generated by the alternator, accessories for receiving a supply of electric power stored in the battery, a key cylinder arranged in an electric circuit connecting the battery and the accessories, a gate lock switch switchable to a lock position where drive of hydraulic equipment by pressure oil delivered from the hydraulic pump is disabled or an unlock position where the drive of the hydraulic equipment is enabled, and a controller for controlling the supply of electric power from the battery to the accessories, wherein an electric circuit, which connects the key cylinder, controller and the accessories, is provided with a first self-holding relay drivable directly by a relay drive signal outputted from the controller and second self-holding relays drivable in conjunction with the first relay; and, when the gate lock switch is switched to the lock position while the engine is running, the controller outputs an engine stop signal at a subsequent predetermined timing to stop the running of the engine, and also outputs the relay drive signal to drive the first relay and the second relay interlocked with the first relay such that a key-on power supply on a downstream side of the key cylinder and an accessory power supply on the downstream side of the key cylinder are each held in a cut-off state.

According to the construction described above, the power source control circuit for the working machine can be provided with idle stop function because, when the gate lock switch is switched to the lock position while the engine is running, an engine stop signal is outputted at a subsequent predetermined timing from the controller to stop the running of the engine. Further, wasteful power consumption can be reduced, because upon an idle stop, a relay drive signal is outputted from the controller to drive the first and second relays such that the key-on power supply and accessory power supply on the downstream side of the key cylinder are each switched in the cut-off state. Furthermore, the key-on power supply and accessory power supply can each be held in the cut-off state even when a power supply for the controller is shut down as a result of the cut-off of the key-on power supply, because self-holding relays are arranged as the first and second relays.

In the above-described power source control, the key-on power supply may preferably be branched into two circuits such that one of the two circuits is used for allowing a drive power supply to occur for the first and second relays and the other circuit is used for allowing a key-on power supply to occur for the controller.

According to the construction described immediately above, returning of the key cylinder to an OFF position, said key cylinder having been switched to an ON position in an idle stop state, releases the self-holding of each relay so that the engine returns from the idle stop state to a normal key-off state, and therefore, the engine can be restarted by operating the key cylinder again. The restart of the engine can hence be made following the same procedure as a normal engine start. Accordingly, the power source control circuit according to the present invention is easy to operate, and makes it possible to provide a working machine, which has idle stop function, with enhanced operability.

According to the present invention, the electric circuit which connects the key cylinder, controller and accessories is provided with the self-holding first relay directly drivable by a relay drive signal outputted from the controller and the self-holding second relays drivable in conjunction with the first relay. At the time of an idle stop, a relay drive signal is outputted from the controller to drive the first and second relays so that the key-on power supply on the downstream side of the key cylinder and the accessory power supply on the downstream side of the key cylinder are each switched to the cut-off state to hold each of them in this state. It is, therefore, possible to reduce wasteful power consumption in a power source control circuit for a working machine equipped with idle stop function, and to prevent battery flattening.

### BRIEF DESCRIPTION OF THE DRAWINGS

FIG. 1 is a circuit diagram of a power source control circuit according to an embodiment of the present invention for a working machine.

FIG. 2 is a block diagram of a main controller arranged in the power source control circuit according to the embodiment of the present invention for the working machine.

FIG. 3 is a flow chart illustrating an operation of the power source control circuit according to the embodiment of the present invention for the working machine.

### DETAILED DESCRIPTION OF PREFERRED EMBODIMENTS

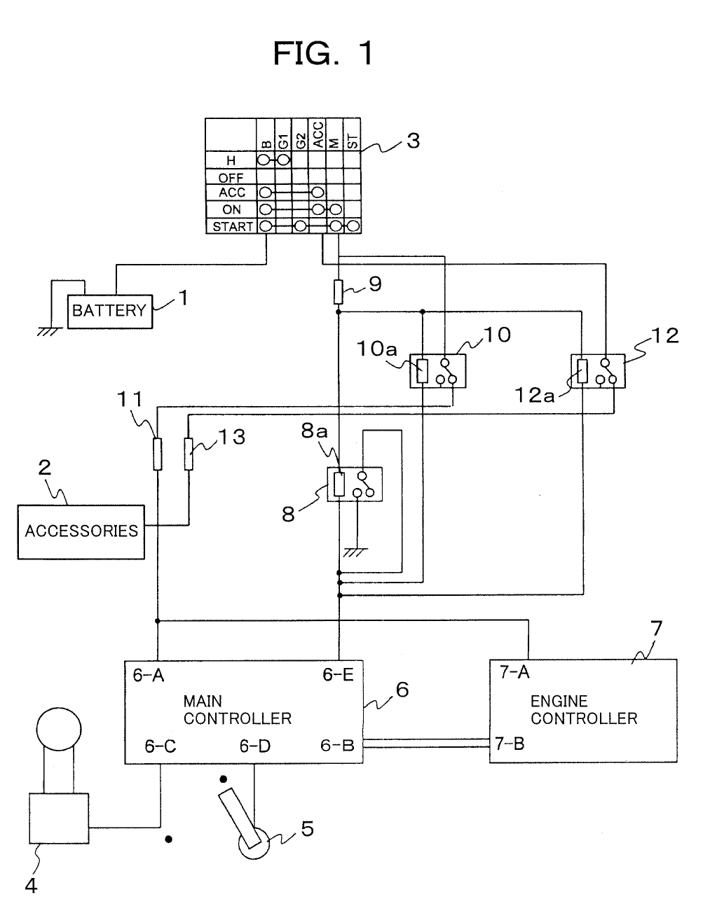

Referring first to FIG. 1, a description will be made of the circuit configuration of the power source control circuit according to the embodiment of the present invention for the working machine.

As shown in FIG. 1, the power source control circuit according to the embodiment of the present invention for the working machine is constructed including a battery 1, accessories 2 such as a radio, a key cylinder 3 arranged in an electric circuit connecting these battery 1 and accessories 2, control levers 4 and a gate lock switch 5 arranged in an operator's cab of the working machine, a main controller 6, and an engine controller 7 for controlling the driving or stop of an unillustrated engine responsive to an instruction from the main controller 6 via a communication path between an input/output port 6-B of the main controller 6 and an input/output port 7-B of the engine controller 7. Stored in the battery 1 is electric power generated at an alternator (now shown) which is driven by the engine. The engine also drives a hydraulic pump as a drive source for the working machine. By manipulating one or more of the control levers 4 to control the flow direction or directions and flow rate or rates of pressure oil delivered from the hydraulic pump and to be fed to an actuator or actuators arranged in the corresponding one or more of hydraulic equipment, the one or more of the hydraulic equipment are driven so that the working machine performs desired work such as digging. From each control lever 4, a control signal corresponding to its control direction and control stroke is outputted, and this control signal is inputted through a control signal input terminal 6-C of the main controller 6.

The gate lock switch 5 is operated by an operator upon entering or exiting the operator's cab, for example, in conjunction with a gate lock lever arranged at an entrance/exit of the operator's cab, and is switched to a lock position where the operation of one or more of the hydraulic equipment by the corresponding control lever or levers 4 is disabled or to an unlock position where the operation of one or more of the hydraulic equipment by the corresponding control lever or levers 4 is enabled. By switching the gate lock switch 5 to the unlock position upon entering the operator's cab, desired one or more of the hydraulic equipment can, therefore, be operated to perform work as desired. Upon exiting the operator's cab, on the other hand, the gate lock switch 5 is switched to the lock position to disable operation of all the hydraulic equipment so that the safety during work stoppage can be assured. From the gate lock switch 5, a switch signal corresponding to the lock position or unlock position is outputted, and this switch signal is inputted through a switch signal input terminal 6-D of the main controller 6.

The key cylinder 3 makes up a so-called ignition switch, and as shown in FIG. 1, has switch positions of OFF, H (heater), ACC (accessory), ON and START. All contacts are placed in a non-conductive state therebetween in the OFF position, a B (battery) contact and a G1 (glow plug 1) contact are selectively placed in a conductive state therebetween in the H position, and the B contact and an ACC contact are selectively placed in a conductive state therebetween in the ACC position. Further, the B contact, the ACC contact and an M (key-on) contact are selectively placed in a conductive state in the ON position, and the B contact, a G2 (glow plug 2) contact, the M contact and an ST (starter) contact are selectively placed in a conductive state therebetween in the START position. Changing to each switch position is achieved through a manipulation of the engine key by the operator. Upon start-up of the engine, the engine key is switched from the OFF position to the ACC position, ON position and START position successively. In the START position, the B contact and ST contact are placed in the conductive state therebetween, and an electric starter motor (not shown) attached to the engine is driven to start up the engine. When the hand is take off from the engine key in this state, the engine key is automatically returned to the ON position by a built-in return spring.

A first electric circuit connecting a key-on power supply on a downstream side of the key cylinder 3 as viewed from the side of the battery 1 and a relay drive signal output terminal 6-E of the main controller 6 is provided with an idle stop relay 8 as the first relay and a fuse 9 connected in series with the idle stop relay 8. A second circuit connecting the key-on power supply and key-on signal input terminals 6-A, 7-A of the main controller 6 and engine controller 7 is provided with a key-on cut relay 10 as one of the second relays and a fuse 11 connected in series with the key-on cut relay 10. Further, a third electric circuit connecting an accessory power supply on the downstream side of the key cylinder 3 and the accessories 2 is provided with an accessory cut relay 12 as the other second relay and a fuse 13 connected in series with the accessory cut relay 12.

The idle stop relay 8 is a normally-open relay, and upon performing an idle stop, is switched to a conductive state. On the other hand, the key-on cut relay 10 and accessory cut relay 12 are normally-closed relays, and upon conducting an idle stop, are each switched to a non-conductive state. These relays 8,10,12 are all self-holding relays, and are provided with coils 8a, 10a, 12a, respectively, for the attraction of their movable coils. These coils 8a, 10a, 12a are each connected to a circuit branched from the key-on power supply. The coil 8a is excited responsive to a relay drive signal outputted from the main controller 6 so that the movable contact of the idle stop relay 8 is switched to a conductive state. On the other hand, the coils 10a, 12a are excited as a result of the switching of the idle stop relay 8 to the conductive state so that the movable contacts of the key-on cut relay 10 and accessory cut relay 12 are each switched to a non-conductive state.

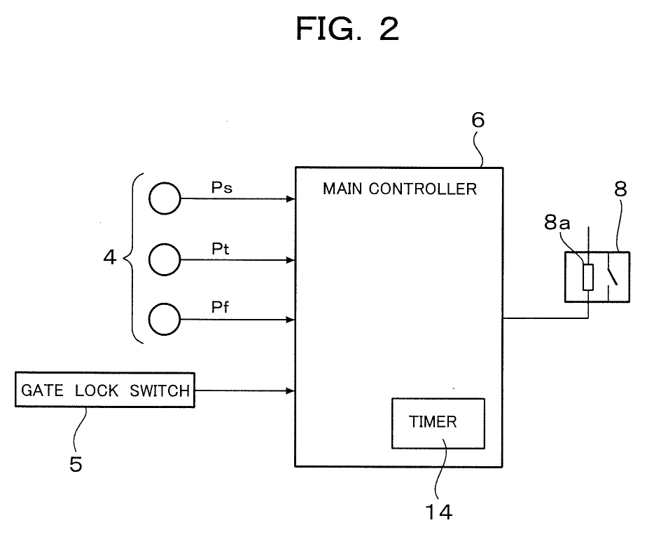

As depicted in FIG. 2, the main controller 6 is provided with a timer 14, in which a time until the output of a relay drive signal from switching of the gate lock switch 5 to the lock position is set. The set time of the timer 14 is determined in view of the actual working conditions of the working machine. Described specifically, at a work site of a working machine such as a hydraulic excavator, the working machine may be on standby with the engine being kept running in such a situation as awaiting a dump truck for the transfer of earth, sand or gravel in the course of performance of predetermined work such as digging. Therefore, a time generally required for another work or thing to do is set to avoid such a situation that the engine would stop during the standby and would need a restart when the operator enters the operator's cab again. As this time, several tens seconds to several minutes are set normally. It is to be noted that the signs “Ps”,“Pt”,“Pf” depicted in this figure indicate a swing pilot pressure, travel pilot pressure and front accessory pilot pressure, all of which are control signals outputted from the corresponding control levers 4.

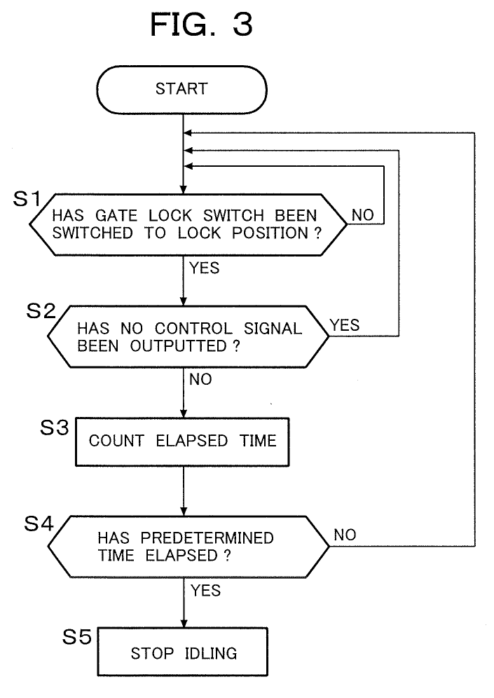

With reference to FIGS. 1 and 3, a description will hereinafter be made about the operation of the power source control circuit according to this embodiment for the working machine.

When the key cylinder 3 is in the OFF position, the idle stop relay 8 is in the non-conductive state, while the key-on cut relay 10 and accessory cut relay 12 are each in the conductive state, as shown in FIG. 1. When the operator enters the operator's cab of the working machine and switches the key cylinder 3 to the ACC position, the battery 1 and accessories 2 are brought into conduction via the accessory cut relay 12 so that use of the accessories is enabled. When the key cylinder 3 is then switched to the ON position, a key-on power supply occurs on a downstream side of the key cylinder 3 so that the main controller 6 and engine controller 7 are booted. When the key cylinder 3 is switched from this state to the START position, electric power is supplied from the battery 1 to the unillustrated electric starter motor so that the engine is started up. As a consequence, the hydraulic pump is driven. The operator can, therefore, perform desired work by manipulating the corresponding one or more of the control levers 4.

After booting, the main controller 6 repeatedly determines whether or not the gate lock switch 5 has been switched to the lock position (step S1 in FIG. 3) and also whether or not there is no control signal outputted from any control lever 4 (step S2 in FIG. 3). If the operator switches the gate lock switch 5 to the lock position with the engine being kept running, for example, to await a dump truck in the course of work such as digging, the gate lock switch 5 is determined to have been switched to the lock position (determined “YES” in step S1), and further, no control signal is determined to have been outputted from the control lever 4 (determined “NO” in step S2). At this time, the main controller 6 counts with the built-in timer 14 the time elapsed since the switching of the gate lock switch 5 to the lock position (step S3 in FIG. 3), and determines whether or not the counted time has reached a preset time (step S4 in FIG. 3). When the counted time is not determined to have reached the preset time (determined “NO” in step S4), steps S1 to S4 are repeated. When the counted time is determined to have reached the preset time (determined “YES” in step S4), the main controller 6 outputs an engine stop signal to the engine controller 7, and based on this engine stop signal, the engine controller 7 stops the engine, in other words, idling (step S5 in FIG. 3). In addition, the main controller 6 outputs a relay drive signal from the relay drive signal output terminal 6-E concurrently with the output of the engine stop signal.

When the relay drive signal is outputted from the main controller 6, the coil 8a is excited so that the idle stop relay 8 is switched to the conductive state. As a result of the switching of the idle stop relay 8, the coils 10a, 12a are also excited so that the key-on cut relay 10 and accessory cut relay 12 are each switched to the non-conductive state. As a consequence, the key-on power supply and accessory power supply on the downstream sides of the key cylinder 3 are shut off. Owing to the use of self-holding relays as the relays 8, 10, 12, this state is not released even after the power supply for the main controller 6 is shut down subsequent to the completion of predetermined processing as a result of the shut-down of the key-on power supply, but is held until the operator switches the key cylinder 3 to the OFF position. Wasteful consumption of the electric power stored in the battery 1 can, therefore, be reduced to prevent battery flattening.

In the power source control circuit according to this embodiment, the key-on power supply is branched into two circuits, one of the two circuits is used to allow a drive power supply to occur for the relays 8, 10, 12, and the other circuit is used to allow a key-on power supply to occur for the main controller 6 and engine controller 7. The self-holding of the respective relays 8,10,12 can, therefore, be released by returning the key cylinder 3, which has been switched to the ON position, to the OFF position after an idle stop. It is, hence, possible to restart the engine by the same procedure as the usual engine start. The working machine equipped with idle stop function can thus be provided with enhanced operability.

The above-described embodiment is constructed to perform an idle stop by outputting a relay drive signal from the main controller 6 concurrently with the output of an engine stop signal from the main controller 6. However, the gist of the present invention is not limited to such a construction, but may take a structure that an idle stop is performed at a predetermined timing after an engine stop signal is outputted.

1. A power source control circuit for a working machine, said power source control circuit comprising an engine for driving a hydraulic pump and an alternator, a battery for storing electric power generated by the alternator, accessories for receiving a supply of electric power stored in the battery, a key cylinder arranged in an electric circuit connecting the battery and the accessories, a gate lock switch switchable to a lock position where drive of hydraulic equipment by pressure oil delivered from the hydraulic pump is disabled or an unlock position where the drive of the hydraulic equipment is enabled, and a controller for controlling the supply of electric power from the battery to the accessories, wherein:
an electric circuit, which connects the key cylinder, the controller and the accessories, is provided with a first self-holding relay drivable directly by a relay drive signal outputted from the controller and second self-holding relays drivable in conjunction with the first relay; and
when the gate lock switch is switched to the lock position while the engine is running, the controller outputs an engine stop signal at a subsequent predetermined timing to stop the running of the engine, and also outputs the relay drive signal to drive the first relay and the second relay interlocked with the first relay such that a key-on power supply on a downstream side of the key cylinder and an accessory power supply on the downstream side of the key cylinder are each held in a cut-off state.

2. The power source control circuit for a working machine according to claim 1, wherein the key-on power supply is branched into two circuits, one of the two circuits is used for allowing a drive power supply to occur for the first and second relays, and the other circuit is used for allowing a key-on power supply to occur for the controller.
